(19) United States
(12) Patent Application Publication
(10) Pub. No.: US 2025/0035035 A1
(43) Pub. Date: Jan. 30, 2025

(54) SCALABLE ENERGY GENERATOR

(71) Applicant: WB Development Company LLC, Marlborough, MA (US)

(72) Inventor: Walter T. Bonin, Marlborough, MA (US)

(73) Assignee: WB Development Company LLC, Marlborough, MA (US)

(21) Appl. No.: 18/767,659

(22) Filed: Jul. 9, 2024

Related U.S. Application Data
(60) Provisional application No. 63/525,818, filed on Jul. 10, 2023.

(51) Int. Cl. F02B 63/04; F02B 1/02; F02B 9/08; H02K 7/18

(52) U.S. Cl. CPC F02B 63/042; F02B 1/02; F02B 9/08; H02K 7/1815

(57) ABSTRACT

Embodiments of the present innovation relate to a scalable energy generator. In one arrangement, the scalable energy generator includes an alternator disposed in operable communication with a rotary valve engine. Each rotary valve includes a rotary drive mechanism which includes a first rotary valve gear coupled to a transmission gear associated with the compression assembly of the engine and a second rotary valve gear connected to a corresponding rotary valve via a shaft. Each of the first rotary valve gear and second rotary valve can be configured as a spiral bevel gear having a set of helically shaped teeth.

### RELATED APPLICATIONS

This patent application claims the benefit of U.S. Provisional Application No. 63/525,818 filed on Jul. 10, 2023, entitled “Scalable Energy Generator,” the contents and teachings of which are hereby incorporated by reference in their entirety.

### BACKGROUND

Electrical generators typically convert fuel into electricity for use in an external circuit. For example, a homeowner can utilize an electrical generator to provide backup electricity to his or her home.

### SUMMARY

Conventional electrical generators suffer from a variety of deficiencies. For example, electrical generators typically include a combustion engine configured to ignite an air-fuel mixture within a combustion channel. The expansion of the detonated air-fuel mixture generates a force on a piston which, in turn, rotates a rotor shaft of the generator. Rotation of the rotor shaft converts the mechanical energy of the piston into electrical energy. However, the combustion engines typically utilized by the electrical generators are relatively inefficient. For example, conventional combustion engines are typically approximately 20% efficient, meaning that these engines convert only about 20% of the energy provided by the air-fuel mixture into linear translation of a piston and rotation of the rotor shaft.

Further, conventional combustion engines can include a number of pistons attached to a common crankshaft and arranged in a slanted or V configuration. However, such an arrangement, such as found in an odd-fire V6 engine arrangement, can generate a highly variable mean torque output relative to angular crankshaft position.

By contrast to conventional electrical generators, embodiments of the present innovation relate to a scalable energy generator. In one arrangement, the scalable energy generator includes an alternator disposed in operable communication with a rotary valve engine. Each rotary valve includes a rotary drive mechanism which includes a first rotary valve gear coupled to a transmission gear associated with a compression assembly of the engine and a second rotary valve gear connected to a corresponding rotary valve via a shaft. Each of the first rotary valve gear and second rotary valve can be configured as a spiral bevel gear having a set of helically shaped teeth.

Meshing of the helically shaped teeth of each gear allows the rotary drive mechanism to define and maintain an offset distance L between the rotational axis of each rotary valve and a radial axis of the flywheel of the compression assembly. Further, use of the helically shaped teeth of each gear allows the shafts of adjacent rotary valves to be disposed at an angle of less than 90° relative to each other. As such, the use of the spiral bevel first and second rotary valve gears allows a relatively large number of rotary valves (e.g., greater than four) to be utilized as part of the engine, thereby increasing the torque generated by the drive shaft of the engine and the amount of electricity produced by the alternator.

The scalable energy generator can be configured in a variety of sizes. For example, the engine of the energy generator can be between about 50 feet and 100 feet in diameter. With such a configuration, the energy generator can generate a relatively large amount of electricity in a decentralized manner.

In one arrangement, the scalable energy generator is configured to provide EPM safety to the engine and to provide relatively low emissions and high efficiency. In one arrangement, the scalable electric generator can utilize natural gas as the fuel source.

Embodiments of the innovation relate to an engine, comprising: a housing defining: an annular combustion channel disposed at an outer periphery of the housing, and an annular compression channel disposed at an outer periphery of the housing and disposed at an axial location parallel to the annular combustion chamber; a set of combustion pistons disposed within the combustion channel; a set of compression pistons disposed within the compression channel; a set of rotary valves, each rotary valve of the set of rotary valves disposed within both the combustion channel and the compression channel; and a rotary drive mechanism connected to each rotary valve of the set of rotary valves, the rotary drive mechanism comprising a first rotary valve gear coupled to a transmission gear associated with the set of combustion pistons and a second rotary valve gear connected to a corresponding rotary valve via a shaft, the rotary drive mechanism configured to position each rotary valve of the set of rotary valves: between a first position to align each rotary valve in the combustion channel to allow a combustion piston of the set of combustion pistons to travel within the combustion channel from a first location to a second location relative to each respective rotary valve of the set of rotary valves and a second position to define a combustion chamber relative to the combustion piston at the second location, and between a first position to align each rotary valve in the compression channel to allow a compression piston of the set of compression pistons to travel within the compression channel from a first location to a second location relative to each respective rotary valve of the set of rotary valves and a second position to define a compression chamber relative to the compression piston at the second location.

Embodiments of the innovation relate to an energy generator, comprising: engine, comprising: a housing defining: an annular combustion channel disposed at an outer periphery of the housing, and an annular compression channel disposed at an outer periphery of the housing and disposed at an axial location parallel to the annular combustion chamber; a set of combustion pistons disposed within the combustion channel; a set of compression pistons disposed within the compression channel; a set of rotary valves, each rotary valve of the set of rotary valves disposed within both the combustion channel and the compression channel; and a rotary drive mechanism connected to each rotary valve of the set of rotary valves, the rotary drive mechanism comprising a first rotary valve gear coupled to a transmission gear associated with the set of combustion pistons and a second rotary valve gear connected to a corresponding rotary valve via a shaft, the rotary drive mechanism configured to position each rotary valve of the set of rotary valves: between a first position to align each rotary valve in the combustion channel to allow a combustion piston of the set of combustion pistons to travel within the combustion channel from a first location to a second location relative to each respective rotary valve of the set of rotary valves and a second position to define a combustion chamber relative to the combustion piston at the second location, and between a first position to align each rotary valve in the compression channel to allow a compression piston of the set of compression pistons to travel within the compression channel from a first location to a second location relative to each respective rotary valve of the set of rotary valves and a second position to define a compression chamber relative to the compression piston at the second location; and an alternator disposed in operative communication with the set of combustion pistons an alternator via a shaft.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic depiction of an example of an energy generator, according to one arrangement.

FIG. 2 illustrates a schematic depiction of a side-sectional view of a circulating piston engine of FIG. 1, according to one arrangement.

FIG. 3 illustrates a schematic depiction of an overhead sectional view of a combustion channel of the engine of FIG. 2, according to one arrangement.

FIG. 4 illustrates a side-schematic view of a rotary drive mechanism of the engine of FIG. 3, according to one arrangement.

FIG. 5 illustrates a top view of the rotary drive mechanism of the engine of FIG. 4, according to one arrangement.

FIG. 6 illustrates a schematic depiction of operation of a rotary valve relative to a combustion channel and compression channel of the engine of FIG. 2, according to one arrangement.

FIG. 7 illustrates a top view of a schematic depiction of horizontal positioning of a glow plug within a combustion channel of the engine of FIG. 1, according to one arrangement.

FIG. 8 illustrates a side view of a schematic depiction of the horizontal positioning of the glow plug within the combustion channel of the engine of FIG. 7, according to one arrangement.

FIG. 9 illustrates a top view of a schematic depiction of a fuel introduction mechanism within a combustion channel of the engine of FIG. 1, according to one arrangement.

FIG. 10 illustrates a side view of a schematic depiction of the fuel introduction mechanism within a combustion channel of the engine of FIG. 9, according to one arrangement.

FIG. 11 illustrates a schematic depiction of the engine of FIG. 1 having an expandable combustion chamber, according to one arrangement.

FIG. 12 illustrates a schematic depiction of positioning of a fuel injector of the engine of FIG. 1, according to one arrangement.

### DETAILED DESCRIPTION

Embodiments of the present innovation relate to a scalable energy generator. In one arrangement, the scalable energy generator includes an alternator disposed in operable communication with a rotary valve engine. Each rotary valve includes a rotary drive mechanism which includes a first rotary valve gear coupled to a transmission gear associated with a compression assembly of the engine and a second rotary valve gear connected to a corresponding rotary valve via a shaft. Each of the first rotary valve gear and second rotary valve can be configured as a spiral bevel gear having a set of helically shaped teeth.

Meshing of the helically shaped teeth of each gear allows the rotary drive mechanism to define and maintain an offset distance L between the rotational axis of each rotary valve and a radial axis of the flywheel of the compression assembly. Further, use of the helically shaped teeth of each gear allows the shafts of adjacent rotary valves to be disposed at an angle of less than 90° relative to each other. As such, the use of the spiral bevel first and second rotary valve gears allows a relatively large number of rotary valves (e.g., greater than four) to be utilized as part of the engine, thereby increasing the torque generated by the drive shaft of the engine and the amount of electricity produced by the alternator.

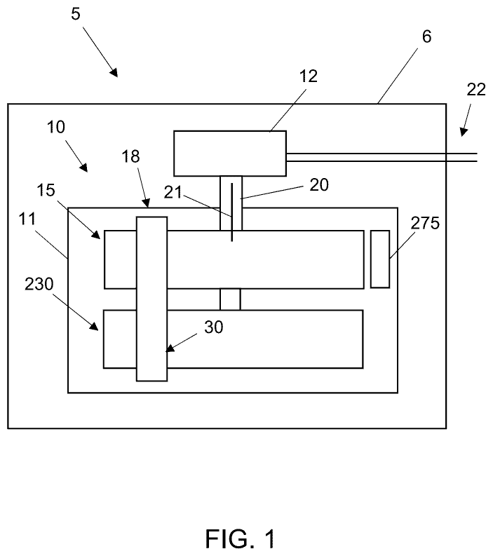

FIG. 1 illustrates a schematic depiction of an example of a scalable energy generator 5, such as an electrical generator, according to one arrangement. The scalable energy generator 5 includes a housing 6 which contains a circulating piston engine 10 disposed in operative communication with an alternator 12 via shaft 20. The engine 10 includes a housing 11 that contains a combustion assembly 15, an air compression assembly 230, a rotary valve assembly 18, and an air-fuel distribution assembly 275 configured to provide a mixture of fuel and air to the combustion assembly 15. During operation, the engine 10 is configured to rotate the shaft 20 relative to the alternator 12 which, in turn, causes the alternator 12 to generate electricity. The scalable energy generator 5 is configured to output the electricity via conductors 22 or to store the electricity to a battery (not shown).

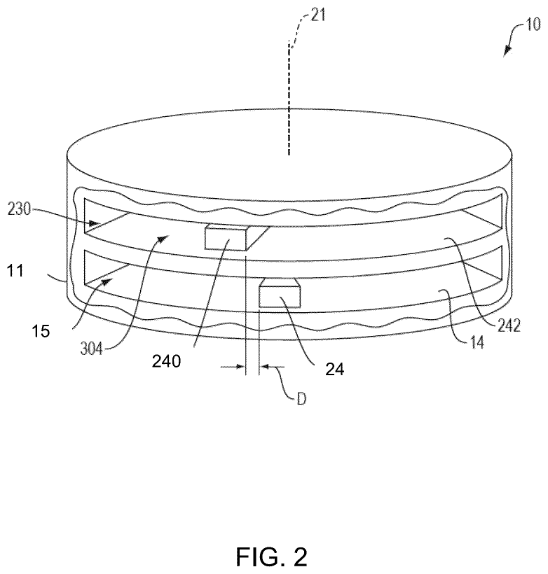

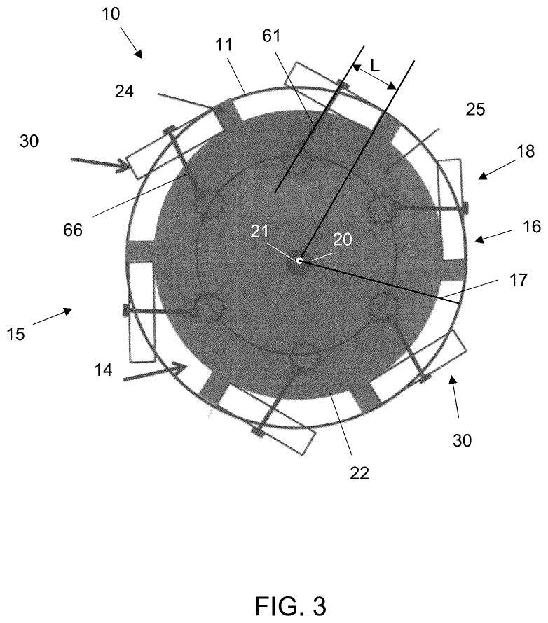

As provided above, the engine 10 can include separate combustion and compression assemblies 15, 230 to decouple the compression process from the combustion process. For example, FIG. 2 illustrates a partial sectional, schematic side view of the circulating piston engine 10 having the combustion assembly 15 and a parallel and longitudinally-disposed air compression assembly 230. Further, FIG. 3 illustrates an overhead, cross-sectional, schematic view of the combustion assembly 15 of the circulating piston engine 10, according to one arrangement.

With reference to FIGS. 2 and 3, the combustion assembly 15 includes an annular channel or bore 14 defined by the housing 11 of the engine 10 and a combustion piston assembly 16. The annular bore 14 is disposed at an outer periphery of the housing 11. While the annular bore or combustion channel 14 can be configured in a variety of sizes, in one arrangement, the annular bore 14 is configured as having a radius 17 of about twenty-five feet and fifty feet relative to an axis of rotation 21 of the combustion piston assembly 16. As will be described below, with such a configuration, the relatively large radius 17 of the annular bore 14 disposes an engine combustion chamber, described in detail below, at a maximal distance from an axis of rotation 21 and allows the combustion piston assembly 16 to generate a relatively large torque on the drive shaft 20 as disposed co-linearly with at the axis of rotation 21. The combustion piston assembly 16 is disposed within the annular bore 14 and is coupled to the drive shaft 20 via a flywheel 22.

The annular bore 14 can be configured with a cross-sectional area having a variety of shapes. In one arrangement, in the case where a piston 24 of the combustion piston assembly 16 defines a generally rectangular shape, the annular bore 14 can also define a corresponding rectangular cross-sectional area. In one arrangement, the rectangular cross-sectional area of the annular bore 14 can include a width to height ratio of about 1:2.8 to correspond with the size of the piston 24 moving within the bore 14.

During operation, the pistons 24 of the combustion piston assembly 16 are configured to rotate within the annular bore 14. For example, as illustrated, the pistons 24 are configured to rotate within the annular bore 14 in a clockwise direction. However, it should be noted that the pistons 24 can rotate within the annular bore 14 in a counterclockwise manner as well. Such rotation causes rotation of the shaft 20 about the axis of rotation 21.

Returning to FIG. 2, the air compression assembly 230 is configured as a source of compressed air for the engine 10 which can be delivered to fuel injectors during operation. In one arrangement, the air compression assembly 230 can include an annular compression channel 242 defined by the housing 11. As illustrated, the compression channel 242 can be disposed axially above, and substantially parallel to, the combustion channel 14 along the axis of rotation 21. The air compression assembly 230 also includes a compression piston assembly 304 disposed within the annular compression channel 242. The compression piston assembly 304 can include a set of compression pistons 240 coupled to the drive shaft 20 and disposed within the annular compression channel 242.

During operation, both sets of pistons 24, 240 are configured to rotate at substantially the same rate. As illustrated in FIG. 2, each compression piston 240 is disposed at an offset distance D proximal to each respective piston 240. The offset distance D allows a single rotary valve 30 having a single opening 100 to serve as the rotary valve for a given pair of pistons 24, 240 within both channels 14, 242.

With additional reference to FIGS. 1 and 3, the rotary valve assembly 18 includes a set of rotary valves 30, each configured to define a combustion chamber relative to a respective piston 24 of the combustion piston assembly 16 within the annular bore 14 and to define a compression chamber relative to a respective piston 240 of the air compression assembly 230.

Each rotary valve 30 of the rotary valve assembly 18 is manufactured as a substantially circular, cup-shaped structure having a loop-shaped wall structure 50 and a face plate. While each rotary valve 30 can be manufactured from a variety of materials, in one arrangement, the rotary valves 30 are manufactured from one or more materials capable of withstanding combustion temperatures in excess of about 4000° F. and pressures of about 1000 pounds per square inch (psi) while rotating relative to the housing 12.

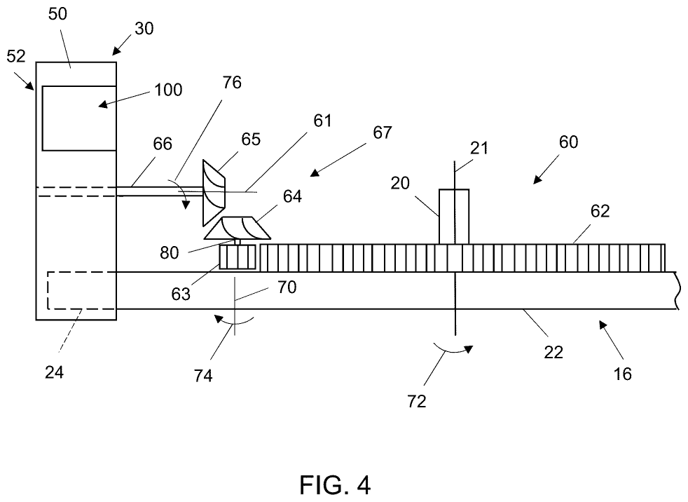

With reference to FIG. 4, the loop-shaped wall structure 50 of the rotary valve 30 defines an opening or slot 100 configured to allow each of the pistons 24, 240 to rotate within the respective annular bores 14, 242 when the slot 100 is aligned with a corresponding piston 24 240, as will be described in detail below.

As provided above, the circulating piston engine 10 is configured to be utilized as part of a scalable energy generator 5 which is scalable in size. For a generator 5 configured to generate a relatively large amount of electricity, such as a decentralized power generator, the circulating piston engine 10 can include a number of combustion pistons 24, compression pistons 240, and rotary valves 30. For example, in the arrangement illustrated in FIG. 3, the combustion piston assembly 16 can include six combustion pistons 24 disposed about the periphery of the flywheel 22 with adjacent pistons 24 being disposed at an angular orientation of about 60° relative to each other. Further as shown, the rotary valve assembly 18 can include six rotary valves 30 corresponding to the six combustion pistons 24 of the combustion piston assembly 16. Additionally, while not illustrated, in one arrangement, the compression piston assembly 304 can include six compression pistons 240 with adjacent pistons 240 being disposed at an angular orientation of about 60° relative to each other.

In one arrangement, the engine 10 can include a rotary drive mechanism 60 configured to rotate each rotary valve 30 relative to the combustion piston assembly 16 and the compression piston assembly 304. However, to accommodate the inclusion of six or more rotary valves 30, the rotational axis 61 of each rotary valve 30 is offset by a distance L relative to a radial axis 21 of the combustion piston assembly 16. Further, the rotational axis 61 of each rotary valve 30 is disposed within the engine 10 at an angular orientation of about 60° relative to each adjacent rotary valve 30. As such, the rotary drive mechanism 60 includes rotary gear elements configured to provide rotational coupling between the flywheel 22 and each rotary valve 30 while maintaining the offset distance L between the rotational axis 61 of each rotary valve 30 and the radial axis 21 and the relative orientation of each adjacent rotary valve 30 during operation.

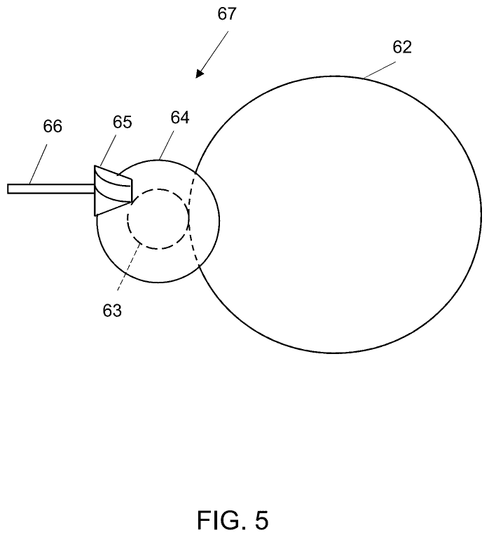

For example, FIG. 4 illustrates a side schematic view of a rotary drive mechanism 60 of the engine 10. The rotary drive mechanism 60 includes a drive gear 62, a transmission gear 63 and a rotary valve gear assembly 67. A top view of the rotary valve gear assembly 67 is shown in FIG. 5.

With reference to FIG. 4, the drive gear 62 is coupled to the flywheel 22 of the combustion piston assembly 16. As such, the drive gear 62 is configured to rotate with the flywheel 22 as the flywheel 22 rotates within the engine 10. While the drive gear 62 can be configured in a variety of ways, in one arrangement, the drive gear 62 is configured as a spur gear.

The transmission gear 63 is configured to mesh with the drive gear 62 to transmit the rotational movement of the drive gear 62 to the rotary valve gear assembly 67. While the transmission gear 63 can be configured in a variety of ways, in one arrangement, the transmission gear 63 is configured as a spur gear.

The rotary valve gear assembly 67 is configured to convert the lateral rotational motion of the drive gear 62 about longitudinal axis 21 into vertical rotational motion of the rotary valve 30 about axis 61. In one arrangement, the rotary valve gear assembly 67 includes a first rotary valve gear 64 coupled to the transmission gear 63, such as via shaft 80 and a second rotary valve gear 65 connected to a corresponding rotary valve 30, such as via shaft 66. For example, the shaft 66 extends into the loop-shaped wall structure 50 of a corresponding rotary valve 30 and connects to that rotary valve's face plate 52 such that a longitudinal axis of the shaft 66 is substantially collinear with the axis of rotation 61 of the rotary valve 30.

Each of the first and second rotary valve gears 64, 65 are configured to provide rotational coupling between the flywheel 22 and a corresponding rotary valve 30. For example, each of the first and second rotary valve gears 64, 65 can be configured as a spiral bevel gear having a set of helically shaped teeth. Meshing of the helically shaped teeth of each gear 64, 65 allows the rotary drive mechanism 60 to define and maintain the offset distance L between the rotational axis 61 of each rotary valve 30 and the radial axis 21 of the flywheel 22. Further, use of the helically shaped teeth of each gear 64, 65 allows the shafts 66 of adjacent rotary valves 30 to be disposed at an angle of less than 90° relative to each other. As such, the use of the spiral bevel first and second rotary valve gears 64, 65 allows a relatively large number of rotary valves (e.g., greater than four) to be utilized as part of the engine 10, thereby increasing the torque generated by the drive shaft 20 and the amount of electricity produced by the alternator 12

During operation, as fly wheel 22 and drive gear 62 rotate, each of the corresponding rotary valve gears 65, shafts 66, and rotary valves 30 rotate as well. For example, rotation of the drive shaft 20 and drive gear 62 in a counter clockwise direction 72 about the axis of rotation 21 causes the transmission gear 63 and the first rotary valve gear 64 of a rotary valve gear assembly 67 to rotate in a clockwise direction 74 about rotational axis 70. Rotation of the first rotary valve gear 64 in a clockwise direction 74 causes the second rotary valve gear 65, as well as the corresponding shaft 66 and rotary valve 30, to rotate about the rotary axis 61 in a counter clockwise direction 76.

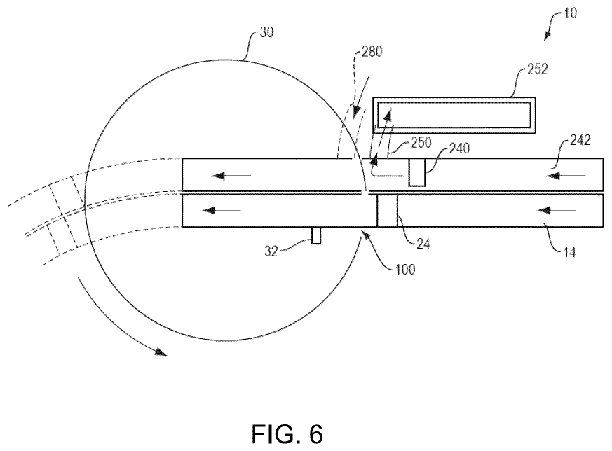

With additional reference to FIG. 6, operation of the rotary drive mechanism 60 can rotate each rotary valve 30 relative to the combustion and compression channels 14, 240. For example, during operation, the combustion piston 24 and the compression piston 240 rotate in their respective channels 14, 242 while the rotary drive mechanism 60 rotates a rotary valve 30 to a first position relative to the combustion and compression channels 14, 242. With such positioning, as illustrated, the opening 100 of the rotary valve 30 is aligned within the combustion channel 14 such that the combustion piston 24 can rotate past the rotary valve 30. Also with such positioning, a portion of the wall 50 of the rotary valve 30 is disposed within the compression channel 242 to form a bulkhead relative to the compression piston 240. As the compression piston 240 rotates toward the rotary valve 30, the compression piston 240 compresses the air contained within the compression channel 242 between the piston 240 and the rotary valve 30 to a pressure of about 176 psi. The compressed air is delivered, via an outlet port 250, to a pressurized air reservoir 252 which is disposed in fluid communication with the compression channel 242. The pressurized air reservoir 252 maintains the pressurized air at a pressure of about 176 psi and can deliver the compressed air to a fuel injector 32.

As the rotary valve 30 continues to rotate via the rotary drive mechanism 60, the valve 30 is disposed in a second position relative to the combustion and compression channels 14, 242. In this position, the opening 100 becomes aligned with the compression channel 242 which allows the compression piston 240 to continue to rotate within the compression channel 242 past the rotary valve 30. Further, with the combustion piston 24 having travelled past the rotary valve 30, the combustion piston 24 defines a combustion chamber relative to a portion of a wall 50 of the rotary valve 30.

Continued rotation of the rotary valve 30 by the rotary drive mechanism 60 disposes the valve 30 in a third position relative to the combustion and compression channels 14, 242. With such positioning, a portion of a wall 50 of the rotary valve 30 is disposed within the combustion channel 14 to define the combustion chamber 260. Combustion of an air-fuel mixture provided by the fuel injector 32 within the combustion channel 260 drives further rotation of the combustion piston 24 within combustion channel 14. Also, with such positioning of the rotary valve 30, the opening 100 in the rotary valve 30 is aligned with an inlet port 280 while a portion of the rotary valve 30-1 is disposed within the compression channel 242. As the compression piston 240 travels in the compression channel 242, the rotary valve 30 acts as a bulkhead relative to the piston 240 such that the piston 240 draws air 282 into a rearward portion of compression channel 242 via the inlet port 280. Further, rotation of the piston 240 compresses the air 284 in a forward portion against an adjacently disposed, and closed, rotary valve 30.

As provided above, when a portion of the wall 50 of the rotary valve 30 is disposed within the combustion channel 14, a fuel injector 32 then delivers an air-fuel mixture 34 into the combustion chamber, as defined between the wall 50 and a piston 24, which can then be ignited by an ignition device (not shown) such as a spark plug. As the ignition device ignites the air-fuel mixture 34 in the combustion chamber, the expansion of the air-fuel mixture 34 against the rotary valve 30 generates a force on the piston 24 to propel the piston 24 along the rotational travel path defined by the combustion channel 14.

In certain cases, the air-fuel mixture can enter the combustion chamber at a relatively high rate of speed. As such, in order to ignite the air-fuel mixture in a relatively rapid manner, the ignition device can be a glow plug. For example, the glow plug can include a heating element configured to heat and ignite the air-fuel mixture contained within the combustion chamber.

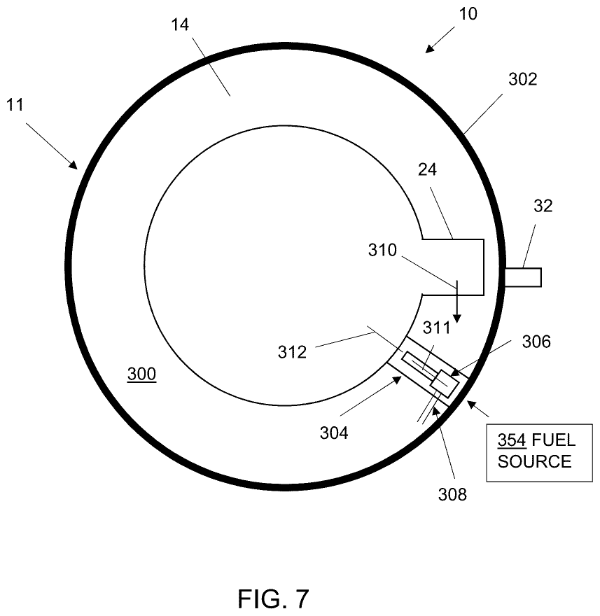

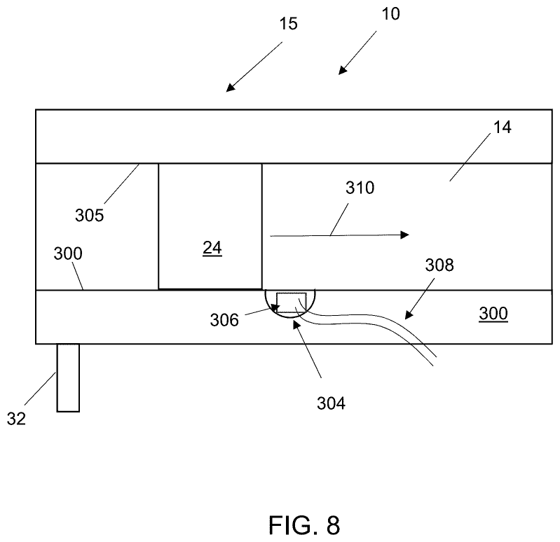

The glow plug can be carried by the engine 10 in a variety of ways. For example, FIGS. 7 and 8 illustrate a sectional view of a portion of the combustion assembly 15 of the engine 10 of FIG. 1. The housing 11 of the engine 10 includes a floor 300, side wall 302, and ceiling 305 to define a combustion channel 14. The engine 10 further defines a fuel trough 304 within the floor 300 and a glow plug 306 disposed horizontally within the trough 304. As illustrated, when positioned in the fuel trough 304, a longitudinal axis 311 of the glow plug 306 is substantially aligned with a longitudinal axis 312 of the fuel trough 304.

In one arrangement, the fuel trough 304 and glow plug 306 are located at an outer periphery of the housing 11 of the engine 10. With such positioning, in the case of failure of the glow plug 306 during operation, an operator can readily access the glow plug 306 for replacement.

During operation, as the piston 24 travels within the combustion channel 14 along direction 310 to a first ignition position over the fuel trough 304 and glow plug 306, a relatively small amount of fuel from a fuel source 354 enters the trough 304. Such positioning of the piston 24 relative to the fuel trough 304 locks the fuel in the trough 304 for a given period of time. Further, with such positioning of piston 24, a signal carried by electrical connectors 308 can be received by the glow plug 306 to activate the heating element which, in turn, can raise the temperature of the fuel in the trough 304 to combustion temperature. The fuel injector 32 provides fuel to the combustion channel 14 as the piston 24 travels to a second ignition position past the fuel trough 304 and glow plug 306. As the piston 24 passes the fuel trough 304 and glow plug 306, the piston allows the fuel located in the combustion chamber from the fuel injector 32 to be exposed to, and ignited by, the burning fuel located in the fuel trough 304 as ignited by the glow plug 306. This timing can be controlled by the relative location of the trough 304 and fuel injector 32 on the engine 10.

While the use of a single glow plug 306 is described above, in one arrangement, the engine 10 can include two or more glow plugs. For example, the engine 10 can include a first glow plug 306 disposed within the fuel trough 304 in a horizontal position, as shown, as well as a second glow plug (not shown) disposed in a vertical position relative to the combustion channel 14 (e.g., into the page). Such a configuration increases the likelihood of combustion of the air-fuel mixture within the combustion channel 14 during operation.

As provided above, the circulating piston engine 10 is configured to be utilized as part of a scalable energy generator 5 which is adjustable or scalable in size. In one arrangement, in order to utilize such a generator as a back-up to significantly-sized energy-generating installations, the engine 10 can be configured as having relatively large dimensions. For example, the engine 10 can be between about 50 feet and 100 feet in diameter with a circumference between about 150 feet and 300 feet. For example, with such a configuration, there can be inefficiencies in distributing fuel to the combustion channel 14 over that distance while maintaining pressure and volume. Further, when using natural gas as the fuel for an engine 10, regardless of size or diameter, the use of fuel injectors to distribute the fuel within the engine 10 can be inefficient.

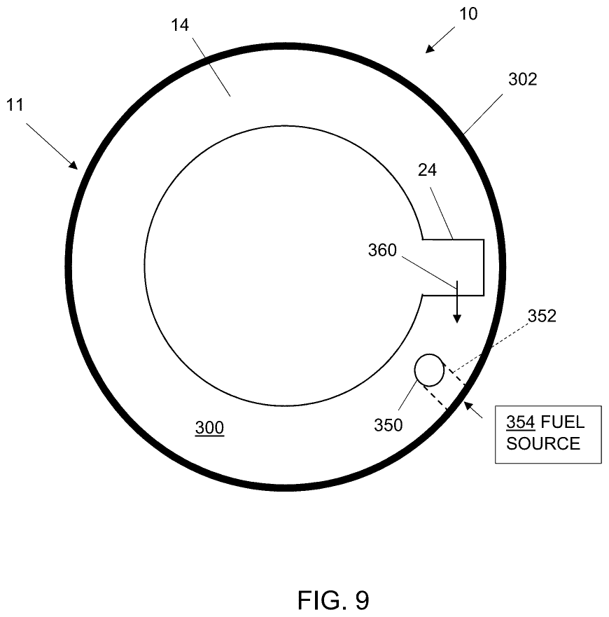

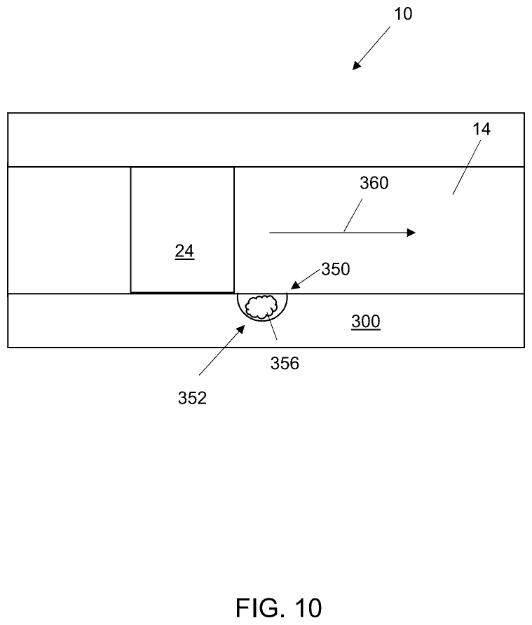

To improve fuel delivery efficiency for a relatively large diameter engine 10, the combustion piston 24 can be configured to create a vacuum within the combustion channel 14 to draw fuel into the combustion channel 14 for detonation. For example, with reference to FIGS. 9 and 10 the floor 300 of the housing 11 of the engine 10 can define a port 350 disposed in fluid communication with a fuel source 354 via a fuel channel 352 defined by the housing 11. During operation, as the combustion piston 24 rotates along direction 360 and passes over the port 350, the combustion piston 24 can draw fuel 356 from the fuel channel 352 into the combustion channel 14. With such a configuration, the engine 10 provides a mechanism to draw fuel 356 into the combustion chamber 14 with adequate pressure, regardless of the size of the engine's diameter, without the need for a fuel injector.

As provided above, the engine 10, such as utilized with a scalable energy generator 5 or with a vehicle, can be required to generate additional power to overcome an increase in output shaft loading. For example, assume a vehicle, such as a truck, carries a relatively heavy load up a hill having a relatively steep grade. In such a case, with conventional engines, a constant (i.e., unchanging) power output from the engine can result in a reduction in the torque output of the engine and a reduction in the velocity of the vehicle.

In one arrangement, in order to maintain the torque output of the engine 10 in the presence of an increased output shaft load, the engine 10 is configured with a combustion chamber expansion system 400 disposed in fluid communication between the combustion chamber 14 and a fuel source 354. The combustion chamber expansion system 400 is configured to increase the amount of fuel provided from the fuel source 354 to the combustion chamber 14 in response to detection of a reduced torque output by the output shaft 22.

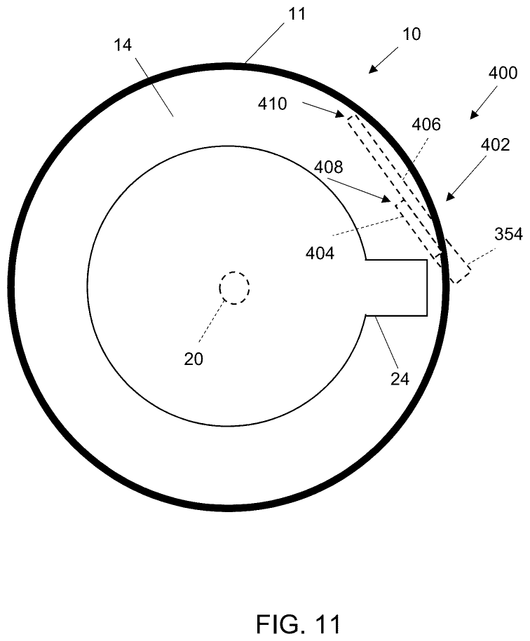

For example, as shown in FIG. 11, the combustion chamber expansion mechanism 400 can be configured as a fuel doubler mechanism 402. As shown, the housing 11 of the engine 10 defines a first fuel delivery pathway 404 and a second fuel delivery pathway 406, each having a distinct length. For example, the first fuel delivery pathway 404 can be configured as a channel having a length L₁ formed within the housing 11 and the second fuel delivery pathway 406 can be configured as a channel having a length L₂ formed within the housing 11. Each of the first and second delivery pathway 404, 406 is disposed in proximity to, and in fluid communication with, a portion of the combustion channel 14. For example, outlet ports 408, 410 of each respective fuel delivery pathway 404, 406 are disposed at different spaced-apart locations relative to the combustion channel 14. Further, the fuel source 354, such as a fuel injector 32, is disposed in fluid communication with both of the first and second fuel delivery pathways 404, 406.

During operation, the fuel source 354 provides fuel, such as an air-fuel mixture or natural gas, to each of the first and second fuel delivery pathways 404, 406. The first and second fuel delivery pathways 404, 406 redirect the fuel along two separate directions such that the fuel enters the combustion channel 14 at two different locations via outlet ports 408, 410. For example, the first fuel delivery pathway 404 can be configured to direct fuel into the combustion channel 14 through outlet port 408 at a location that is proximal to the fuel source 354 while the second fuel delivery pathway 406 can be configured to direct fuel into the combustion channel 14 through outlet port 410 at a location that is distal to the fuel source 354. Effectively, such a configuration of the combustion chamber expansion system 400 doubles the amount of fuel present in the combustion chamber during each combustion. As such, the fuel doubler mechanism 402 allows the engine 10 to generate a relatively increased amount of torque output, such as in cases where an output shaft 22 experiences an increase in output shaft loading during operation.

In one arrangement, the scalable energy generator 5 is configured to selectably open one of the outlet ports 408, 410 in response to detecting a reduced output torque of the engine 10. For example, during conventional operation, the first outlet port 408 can be disposed in an open state while the second outlet port 410 an be disposed in a closed state. As such, the fuel source 354 provides fuel to the combustion chamber 14 through the first fuel delivery pathway 404. As the scalable energy generator 5 identifies a reduction of torque on the output shaft 22, such as via a torque feedback sensor, the scalable energy generator 5 can provide a signal to the fuel doubler mechanism 402 which, in response, can partially or fully open the second outlet port 410 to allow the fuel source 354 to provide fuel to the combustion chamber 14 through the first and second fuel delivery pathways 404, 406.

As provided above, the engine 10 can be configured to operate utilizing an air-fuel mixture as the fuel source. In such a case, in one arrangement and with reference to FIG. 1, the engine 10 can include an air-fuel distribution assembly 275 disposed at an outer periphery of the engine 10 and configured to provide a mixture of fuel and air to the combustion channel 14.

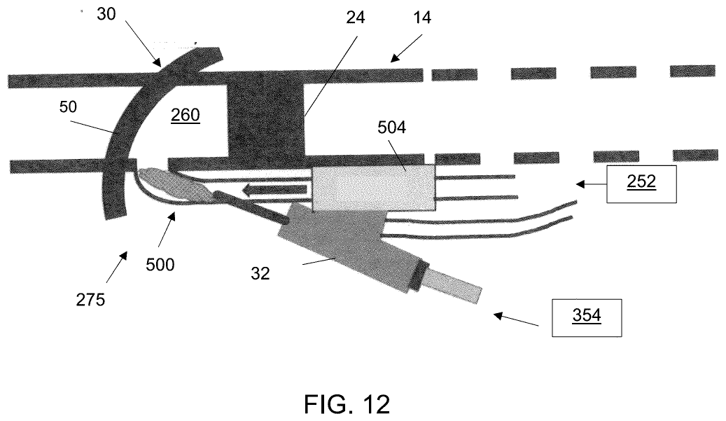

With additional reference to FIG. 12, the air-fuel distribution assembly 275 includes an air-fuel mixing chamber 500 disposed in fluid communication with the combustion channel 14. The air-fuel distribution assembly 275 further includes a fuel injector 32 disposed in fluid communication with a fuel source 354 and with the air-fuel mixing chamber 500. A pressurized air reservoir 252 is also disposed in fluid communication with the air-fuel mixing chamber 500 via air conduit 502. The air-fuel distribution assembly 275 can include an air filter 504 disposed between the pressurized air reservoir 252 and the air-fuel mixing chamber 500 which is configured to remove any impurities present in the pressurized air received from the pressurized air reservoir 252.

During operation, as the combustion piston 24 travels through the combustion channel 14 and passes the rotary valve 30, the rotary valve 30 rotates to dispose a portion of the rotary valve wall 50 within the combustion channel 14, thereby forming a combustion chamber 260 relative to the combustion piston 24. Pressurized air from the pressurized air source 252 enters the air-fuel mixing chamber 500 at the perimeter of the engine 10 and mixes with fuel provided by the fuel injector 32. The air-fuel mixture enters the combustion chamber 260 at a relatively high velocity.

With the air-fuel distribution assembly 275 disposed at the outer perimeter of the engine 10, an operator, such as a service person, can readily access the components of the air-fuel distribution assembly 275. As such, in the event of a malfunction of one or more of the components, the operator can easily access the air-fuel distribution assembly 275 at the perimeter of the engine 10 to replace or repair the components.

While various embodiments of the innovation have been particularly shown and described, it will be understood by those skilled in the art that various changes in form and details may be made therein without departing from the spirit and scope of the innovation as defined by the appended claims.

What is claimed is:

1. An engine, comprising:
a housing defining:
an annular combustion channel disposed at an outer periphery of the housing, and
an annular compression channel disposed at an outer periphery of the housing and disposed at an axial location parallel to the annular combustion chamber;
a set of combustion pistons disposed within the combustion channel;
a set of compression pistons disposed within the compression channel;
a set of rotary valves, each rotary valve of the set of rotary valves disposed within both the combustion channel and the compression channel; and
a rotary drive mechanism connected to each rotary valve of the set of rotary valves, the rotary drive mechanism comprising a first rotary valve gear coupled to a transmission gear associated with the set of combustion pistons and a second rotary valve gear connected to a corresponding rotary valve via a shaft, the rotary drive mechanism configured to position each rotary valve of the set of rotary valves:
between a first position to align each rotary valve in the combustion channel to allow a combustion piston of the set of combustion pistons to travel within the combustion channel from a first location to a second location relative to each respective rotary valve of the set of rotary valves and a second position to define a combustion chamber relative to the combustion piston at the second location, and
between a first position to align each rotary valve in the compression channel to allow a compression piston of the set of compression pistons to travel within the compression channel from a first location to a second location relative to each respective rotary valve of the set of rotary valves and a second position to define a compression chamber relative to the compression piston at the second location.

2. The engine of claim 1, wherein:
the first rotary valve gear comprises a first spiral bevel gear; and
the second rotary gear comprises a second spiral bevel gear.

3. The engine of claim 1, wherein the housing comprises:
a floor, a side wall, and a ceiling configured to define the combustion channel; and
a glow plug disposed within a fuel trough defined by the floor, a longitudinal axis of the glow plug being aligned with a longitudinal axis of the fuel trough, the glow plug configured to ignite an air-fuel mixture contained by the fuel trough.

4. The engine of claim 3, wherein the glow plug is disposed at an outer periphery of the housing.

5. The engine of claim 3, wherein a combustion piston of the set of combustion pistons is configured to be disposed:
in a first ignition position over the fuel trough and glow plug to secure fuel in the fuel trough; and
in a second ignition position past the fuel trough and glow plug to allow fuel located in the combustion chamber to be ignited by the burning fuel located in the fuel trough, as ignited by the glow plug.

6. The engine of claim 1, wherein a combustion piston of the set of combustion pistons is configured to create a vacuum within the combustion channel to draw fuel into the combustion channel for detonation.

7. The engine of claim 6, wherein:
the housing comprises:
a floor, a side wall, and a ceiling configured to define the combustion channel, and
the floor defines a port disposed in fluid communication with a fuel source via a fuel channel defined by the housing; and
wherein the combustion piston of the set of combustion pistons is configured to rotate from a first position to a second position relative to the port to draw fuel into the combustion channel from the fuel source via the fuel channel.

8. The engine of claim 1, comprising a combustion chamber expansion system disposed in fluid communication between the combustion chamber and a fuel source and configured to increase an amount of fuel provided from the fuel source to the combustion chamber in response to detection of a reduced torque output by an output shaft of the engine.

9. The engine of claim 8, wherein the combustion chamber expansion system comprises:
a first fuel delivery pathway having a first length and a first port disposed in fluid communication with the combustion chamber at a first location relative to the fuel source; and
a second fuel delivery pathway having a second length and a second port disposed in fluid communication with the combustion chamber at a second location relative to the fuel source.

10. The engine of claim 1, comprising an air-fuel distribution assembly disposed at an outer periphery of the engine and configured to provide a mixture of fuel and air to the combustion channel.

11. The engine of claim 10, wherein the air-fuel distribution assembly comprises:
an air-fuel mixing chamber disposed in fluid communication with the combustion channel;
a fuel injector disposed in fluid communication with a fuel source and with the air-fuel mixing chamber; and
an air reservoir disposed in fluid communication with the air-fuel mixing chamber.

12. An energy generator, comprising:
an engine, comprising:
a housing defining:
an annular combustion channel disposed at an outer periphery of the housing, and
an annular compression channel disposed at an outer periphery of the housing and disposed at an axial location parallel to the annular combustion chamber;
a set of combustion pistons disposed within the combustion channel;
a set of compression pistons disposed within the compression channel;
a set of rotary valves, each rotary valve of the set of rotary valves disposed within both the combustion channel and the compression channel; and
a rotary drive mechanism connected to each rotary valve of the set of rotary valves, the rotary drive mechanism comprising a first rotary valve gear coupled to a transmission gear associated with the set of combustion pistons and a second rotary valve gear connected to a corresponding rotary valve via a shaft, the rotary drive mechanism configured to position each rotary valve of the set of rotary valves:
between a first position to align each rotary valve in the combustion channel to allow a combustion piston of the set of combustion pistons to travel within the combustion channel from a first location to a second location relative to each respective rotary valve of the set of rotary valves and a second position to define a combustion chamber relative to the combustion piston at the second location, and
between a first position to align each rotary valve in the compression channel to allow a compression piston of the set of compression pistons to travel within the compression channel from a first location to a second location relative to each respective rotary valve of the set of rotary valves and a second position to define a compression chamber relative to the compression piston at the second location; and
an alternator disposed in operative communication with the set of combustion pistons an alternator via a shaft.

13. The energy generator of claim 12, wherein:
the first rotary valve gear comprises a first spiral bevel gear; and
the second rotary gear comprises a second spiral bevel gear.

14. The energy generator of claim 12, wherein the housing comprises:
a floor, a side wall, and a ceiling configured to define the combustion channel; and
a glow plug disposed within a fuel trough defined by the floor, a longitudinal axis of the glow plug being aligned with a longitudinal axis of the fuel trough, the glow plug configured to ignite an air-fuel mixture contained by the fuel trough.

15. The energy generator of claim 14, wherein the glow plug is disposed at an outer periphery of the housing.

16. The energy generator of claim 14, wherein a combustion piston of the set of combustion pistons is configured to be disposed:
in a first ignition position over the fuel trough and glow plug to secure fuel in the fuel trough; and
in a second ignition position past the fuel trough and glow plug to allow fuel located in the combustion chamber to be ignited by the burning fuel located in the fuel trough, as ignited by the glow plug.

17. The energy generator of claim 12, wherein a combustion piston of the set of combustion pistons is configured to create a vacuum within the combustion channel to draw fuel into the combustion channel for detonation.

18. The energy generator of claim 17, wherein:
the housing comprises:
a floor, a side wall, and a ceiling configured to define the combustion channel, and
the floor defines a port disposed in fluid communication with a fuel source via a fuel channel defined by the housing; and
wherein the combustion piston of the set of combustion pistons is configured to rotate from a first position to a second position relative to the port to draw fuel into the combustion channel from the fuel source via the fuel channel.

19. The energy generator of claim 12, comprising a combustion chamber expansion system disposed in fluid communication between the combustion chamber and a fuel source and configured to increase an amount of fuel provided from the fuel source to the combustion chamber in response to detection of a reduced torque output by an output shaft of the engine.

20. The energy generator of claim 19, wherein the combustion chamber expansion system comprises:
a first fuel delivery pathway having a first length and a first port disposed in fluid communication with the combustion chamber at a first location relative to the fuel source; and
a second fuel delivery pathway having a second length and a second port disposed in fluid communication with the combustion chamber at a second location relative to the fuel source.

21. The energy generator of claim 12, comprising an air-fuel distribution assembly disposed at an outer periphery of the engine and configured to provide a mixture of fuel and air to the combustion channel.

22. The energy generator of claim 21, wherein the air-fuel distribution assembly comprises:
an air-fuel mixing chamber disposed in fluid communication with the combustion channel;
a fuel injector disposed in fluid communication with a fuel source and with the air-fuel mixing chamber; and
an air reservoir disposed in fluid communication with the air-fuel mixing chamber.
